(19) United States
(12) Patent Application Publication
(10) Pub. No.: US 2024/0313493 A1
(43) Pub. Date: Sep. 19, 2024

(54) ELECTRIC WIRE SUPPLY APPARATUS AND ELECTRIC WIRE PROCESSING APPARATUS

(71) Applicant: Yazaki Corporation, Tokyo (JP)

(72) Inventors: Takuya NAKADA, Makinohara-shi (JP); Yuta SUGANUMA, Makinohara-shi (JP); Akihiro MIZUNO, Makinohara-shi (JP)

(73) Assignee: Yazaki Corporation, Tokyo (JP)

(21) Appl. No.: 18/672,514

(22) Filed: May 23, 2024

Related U.S. Application Data
(63) Continuation of application No. PCT/JP2022/045283, filed on Dec. 8, 2022.

(30) Foreign Application Priority Data
Dec. 27, 2021 (JP) 2021-212939

(51) Int. Cl. H01R 43/052

(52) U.S. Cl. CPC H01R 43/052

(57) ABSTRACT

An electric wire supply apparatus and an electric wire processing apparatus capable of efficiently performing electric wire replacement are provided. An electric wire supply apparatus includes: an electric wire holding arm configured to detachably hold one electric wire; a holding frame configured to arrange a plurality of the electric wire holding arms side by side and individually hold each of the electric wire holding arms such that each of the electric wire holding arms is movable between a standby posture in a standing state and a tilted electric wire supply posture; and a movement mechanism configured to, when an electric wire to be supplied is selected, move the holding frame such that a supply arm for holding the electric wire is positioned at a predetermined supply position and move the supply arm to the electric wire supply posture at the supply position.

The present invention relates to an electric wire supply apparatus and an electric wire processing apparatus for cutting out a segment electric wire and manufacturing a terminal-equipped electric wire. This application is a continuation application of International Application No. PCT/JP2022/045283 filed on Dec. 8, 2022, whose priority is claimed on Japanese Patent Application No. 2021-212939, filed on Dec. 27, 2021. All of the contents of the International Application and the Japanese Patent Application are incorporated herein with reference.

### TECHNICAL FIELD

### Background Art

In the related art, as an example of an electric wire supply apparatus for cutting out a segment electric wire and manufacturing a terminal-equipped electric wire, there is known an electric wire supply apparatus in which a plurality of guide nozzles holding electric wires are held in parallel by a nozzle holder (see, for example, Patent Literature 1). In the electric wire supply apparatus described in Patent Literature 1, when an electric wire to be supplied is selected, the nozzle holder moves such that the guide nozzle of the electric wire is positioned at an electric wire supply position. Then, the electric wire of the guide nozzle is appropriately fed out and supplied at this electric wire supply position.

### CITATION LIST

### Patent Literature

Patent Literature 1: Japanese Patent No. 6336823

### SUMMARY OF INVENTION

### Technical Problem

Here, in the above-described electric wire supply apparatus, when an electric wire other than a plurality of types of electric wires held by the plurality of guide nozzles is to be supplied, an operation such as detaching the nozzle holder from the electric wire supply apparatus, replacing the electric wire and remounting the electric wire may be required. Since such an operation is complicated for an operator, there is room for improvement in the electric wire supply apparatus described above in terms of work efficiency of electric wire replacement.

Accordingly, an object of the invention is to provide an electric wire supply apparatus and an electric wire processing apparatus capable of efficiently performing electric wire replacement focusing on the above problems.

### Solution to Problem

In order to solve the above problems, an electric wire supply apparatus includes an electric wire holding arm formed in a rod shape, configured to detachably hold one electric wire along a length direction of the electric wire holding arm, having one end side as an electric wire protruding end portion from which a tip end of the electric wire protrudes, a holding frame configured to arrange a plurality of the electric wire holding arms side by side with each other along a width direction intersecting the length direction of the electric wire holding arm, each of the plurality of the electric wire holding arms holding respective one of the electric wires of different types, the holding frame being configured to individually hold each of the electric wire holding arms such that each of the electric wire holding arms is movable between a standby posture, in which the length direction of the electric wire holding arm is aligned with the length direction of another electric wire holding arm with the electric wire holding arm being in a standing state in which the electric wire protruding end portion is positioned higher than an end portion on an opposite side of the electric wire holding arm, and an electric wire supply posture in which the electric wire holding arm is tilted such that the electric wire protruding end portion of the electric wire holding arm is positioned lower than the electric wire protruding end portion of the another electric wire holding arm, and a movement mechanism configured to, when an electric wire to be supplied is selected out of the electric wires of different types, move the holding frame such that a supply arm, which is one of the plurality of electric wire holding arms, holding the selected electric wire among the plurality of electric wire holding arms is positioned at a predetermined supply position and then move the supply arm to the electric wire supply posture at the supply position.

### Advantageous Effects of Invention

According to the electric wire supply apparatus and the electric wire processing apparatus including the electric wire supply apparatus, electric wire replacement can be efficiently performed.

### BRIEF DESCRIPTION OF DRAWINGS

FIG. 1 is an external appearance view showing an embodiment of an electric wire processing apparatus.

FIG. 2 is a schematic view showing a main portion for performing cutting of a segment electric wire and terminal crimping in the electric wire processing apparatus shown in FIG. 1.

FIG. 3 is a schematic view showing an example of a terminal-equipped electric wire manufactured in the electric wire processing apparatus shown in FIGS. 1 and 2.

FIG. 4 is an external appearance perspective view showing an electric wire supply portion shown in FIGS. 1 and 2.

FIG. 5 is a view showing a state in which a supply arm is shifted to an electric wire supply posture in the electric wire supply portion shown in FIG. 4.

FIG. 6 is a perspective view showing only one electric wire holding arm shown in FIGS. 4 and 5.

FIG. 7 is a cross-sectional view showing a cross section of an electric wire protruding end portion of the electric wire holding arm shown in FIG. 6 along a line V11-V11 in the drawing.

### DESCRIPTION OF EMBODIMENTS

Hereinafter, an embodiment of an electric wire supply apparatus and an electric wire processing apparatus will be described.

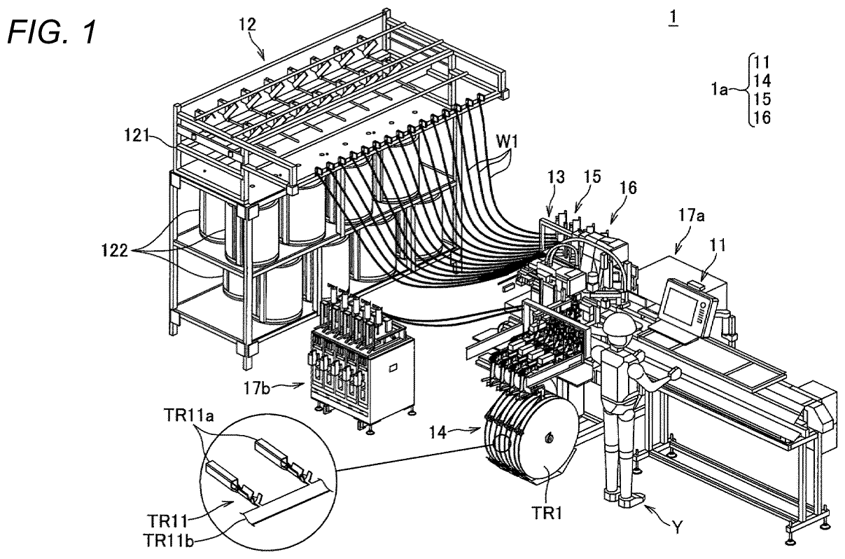

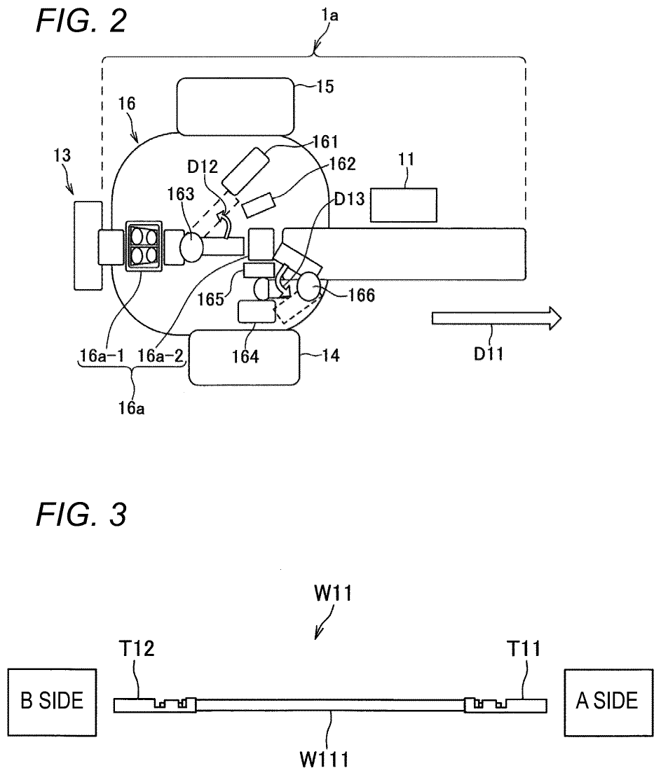

FIG. 1 is an external appearance view showing an embodiment of the electric wire processing apparatus, and FIG. 2 is a schematic view showing a main portion for performing cutting of a segment electric wire and terminal crimping in the electric wire processing apparatus shown in FIG. 1. FIG. 3 is a schematic view showing an example of a terminal-equipped electric wire manufactured in the electric wire processing apparatus shown in FIGS. 1 and 2.

An electric wire processing apparatus 1 shown in FIGS. 1 and 2 is an apparatus for manufacturing a terminal-equipped electric wire W11, for example, one example of which is shown in FIG. 3. FIG. 3 shows the terminal-equipped electric wire W11 in which terminals are crimped to both ends of a segment electric wire W111.

Here, when the terminal-equipped electric wire W11 shown in FIG. 3 is manufactured by the electric wire processing apparatus 1, as to be described later, a supplied electric wire W1 is fed out in a feed-out direction D11 indicated by an arrow in FIG. 2, and the segment electric wire W111 is cut out. At this time, a front side and a rear side in the feed-out direction D11 are referred to as an A side and a B side, respectively, a terminal crimped to the A side of the segment electric wire W111 is referred to as an A-side terminal T11, and a terminal crimped to the B side is referred to as a B-side terminal T12. The terminal-equipped electric wire is not limited to the form of FIG. 3, and the terminal-equipped electric wire may be one in which the terminal is crimped only to one end of the segment electric wire as long as the terminal is crimped to at least one end of the segment electric wire. Further, in the electric wire processing apparatus 1, it is also possible to perform only the cutting of the segment electric wire W111 including stripping of an end portion without performing the terminal crimping. Hereinafter, the electric wire processing apparatus 1 shown in FIGS. 1 and 2 will be described as an apparatus for manufacturing the terminal-equipped electric wire W11 in which the terminals T11 and T12 are crimped to both ends, based on the example of FIG. 3.

The electric wire processing apparatus 1 includes an information acquisition unit 11, an electric wire storage rack 12, an electric wire supply apparatus 13, a B-side terminal supply portion 14, an A-side terminal supply portion 15, a body mechanism 16, an A-side rubber plug supply portion 17a, and a B-side rubber plug supply portion 17b.

In order to manufacture the terminal-equipped electric wire W11, the information acquisition unit 11 acquires manufacturing information including an electric wire type of the segment electric wire W111 and a terminal type of the terminal. Specifically, the information acquisition unit 11 receives an input operation of an operator Y and acquires, as the manufacturing information, portion number data associated with the electric wire type and the terminal type.

In the electric wire storage rack 12, a plurality of electric wire reels 122 of different electric wire types are accommodated in a rack body 121. The electric wires wound around the plurality of electric wire reels 122 are coated electric wires having different thicknesses, colors, and the like. Then, the electric wire W1 pulled out from a predetermined number of electric wire reels 122 selected from among the plurality of electric wire reels 122 is extended to the electric wire supply apparatus 13 as a cutting candidate of the segment electric wire W111.

The electric wire supply apparatus 13 is an apparatus in which an electric wire to be supplied is selected out of a plurality of types of electric wires W1 from the electric wire storage rack 12, and the electric wire is supplied to a supply position for the cutting of the segment electric wire W111 and the terminal crimping. The electric wire supply apparatus 13 will be described in detail later.

Each of the B-side terminal supply portion 14 and the A-side terminal supply portion 15 holds a plurality of types of terminal reels TR1 different in terminal type, and around the terminal reel TR1, a terminal chain body TR11 in which a plurality of terminals TR11a are connected via a band-shaped carrier TR11b is wound. The B-side terminal supply portion 14 holds the plurality of types of terminal reels TR1 as candidates of the B-side terminal T12, and the A-side terminal supply portion 15 holds the plurality of types of terminal reels TR1 as candidates of the A-side terminal T11. Then, the B-side terminal supply portion 14 and the A-side terminal supply portion 15 respectively designate use terminal reels from among the plurality of types of terminal reels TR1 for the B side and the A side, and supply the use terminal reels.

The body mechanism 16 cuts out the segment electric wire W111 from the electric wire supplied from the electric wire supply apparatus 13, and crimps terminals of the supplied use terminal reel to end portions on the B side and the A side of the segment electric wire W111 to manufacture the terminal-equipped electric wire W11. The body mechanism 16 includes a cut-out portion 16a that cuts out the segment electric wire W111 by first feeding out the electric wire in the feed-out direction D11 and cutting the electric wire. The cut-out portion 16a includes a feed-out mechanism 16a-1 that performs feeding out and a cutting mechanism 16a-2 that performs cutting. The cutting mechanism 16a-2 is a mechanism capable of stripping coating on the end portion of the cut electric wire.

Then, the body mechanism 16 includes an A-side crimping machine 161, an A-side rubber plug inserting machine 162, and an A-side electric wire moving arm 163 as mechanism portions for A-side terminal crimping. Here, the A-side terminal crimping refers to terminal crimping performed on a front end of the electric wire in the feed-out direction D11. The A-side crimping machine 161 crimps the terminal of the use terminal reel supplied by the A-side terminal supply portion 15 as the A-side terminal T11 to the front end of the electric wire in the feed-out direction D11. When an A-side rubber plug is supplied from the A-side rubber plug supply portion 17a as to be described later, the A-side rubber plug inserting machine 162 inserts the A-side rubber plug to the front end of the electric wire in the feed-out direction D11 prior to the terminal crimping in the A-side crimping machine 161. In this case, the terminal crimping in the A-side crimping machine 161 is performed from above the inserted rubber plug. The A-side electric wire moving arm 163 is an A-side arm mechanism that grips the electric wire fed out by the cut-out portion 16a, moves the front end of the electric wire in the feed-out direction D11 along a direction indicated by an arrow D12, and positions the electric wire with respect to the A-side crimping machine 161 and the A-side rubber plug inserting machine 162.

Further, the body mechanism 16 includes a B-side crimping machine 164, a B-side rubber plug inserting machine 165, and a B-side electric wire moving arm 166 as mechanism portions for B-side terminal crimping. Here, the B-side terminal crimping refers to terminal crimping performed on a rear end of a terminal-equipped segment electric wire that is cut out after receiving the terminal crimping in the A-side crimping machine 161 in the feed-out direction D11. The B-side crimping machine 164 crimps the terminal of the use terminal reel supplied by the B-side terminal supply portion 14 as the B-side terminal T12 to the rear end of the terminal-equipped segment electric wire in the feed-out direction D11. When a B-side rubber plug is supplied from the B-side rubber plug supply portion 17b as to be described later, the B-side rubber plug inserting machine 165 inserts the B-side rubber plug to the rear end of the terminal-equipped segment electric wire in the feed-out direction D11 prior to the terminal crimping in the B-side crimping machine 164. In this case, the terminal crimping in the B-side crimping machine 164 is performed from above the inserted rubber plug. The B-side electric wire moving arm 166 is a B-side arm mechanism that grips the terminal-equipped segment electric wire cut out by the cut-out portion 16a, that moves the rear end in the feed-out direction D11 along a direction indicated by an arrow D13, and that positions the terminal-equipped segment electric wire with respect to the B-side crimping machine 164 and the B-side rubber plug inserting machine 165.

The A-side rubber plug supply portion 17a and the B-side rubber plug supply portion 17b are apparatuses that hold a plurality of types of rubber plugs and that supply the rubber plugs to the A-side rubber plug inserting machine 162 and the B-side rubber plug inserting machine 165. In the present embodiment, although not shown, the terminal-equipped electric wire W11 can be manufactured by any processing type of a rubber plug insertion type in which the terminal crimping is performed from above the rubber plug and a rubber plug non-insertion type in which the terminal crimping is directly performed on the end portion of the segment electric wire. Further, as the processing type, it is also possible to perform electric wire cutting in which only cut out of the segment electric wire W111 and stripping of the end portion are performed without performing any of the terminal crimping and the rubber plug insertion. In the manufacturing information, that is, the part number data, in addition to the electric wire type and the terminal type, any processing type of the rubber plug insertion type, the rubber plug non-insertion type, and the electric wire cutting, and a rubber plug type in the case of the rubber plug insertion type are associated. The A-side rubber plug supply portion 17a and the B-side rubber plug supply portion 17b respectively supply the rubber plugs of selected rubber plug types to the A-side rubber plug inserting machine 162 and the B-side rubber plug inserting machine 165 in the case of rubber plug insertion type based on the part number data.

In the electric wire processing apparatus 1 schematically described above, prior to the processing of the electric wire, the operator Y inputs the part number data to the information acquisition unit 11. Thereafter, when a start button is pressed, electric wire supply based on the part number data is performed by the electric wire supply apparatus 13, and the supply of respective use terminal reels on the A side and the B side and the supply of respective rubber plugs on the A side and the B side in the case of the rubber plug insertion type are performed. Then, in the body mechanism 16, the electric wire cutting and the manufacture of the terminal-equipped electric wire W11 are performed using the supplied electric wire, the terminal of the use terminal reel, and the rubber plug. The cut segment electric wire W111 and the manufactured terminal-equipped electric wire W11 are discharged to a predetermined accommodation place. In addition, the manufacturing number of the segment electric wires W111 and the electric wires with terminal W11 are also associated with the part number data, and the electric wire cutting and the manufacture of the terminal-equipped electric wire W11 are repeatedly executed until the selected manufacturing number is reached. The electric wire processing apparatus 1 includes the electric wire supply apparatus 13 and an apparatus body 1a, and the apparatus body 1a is a functional portion including the information acquisition unit 11, the B-side terminal supply portion 14, the A-side terminal supply portion 15, and the body mechanism 16. The apparatus body 1a is a portion that receives the supply of the electric wire by pulling out the electric wire supplied by the electric wire supply apparatus 13, that cuts out the segment electric wire W111 from the electric wire, and that manufactures the terminal-equipped electric wire W11 by crimping the terminals to both ends of the segment electric wire W111.

Next, the above-described electric wire supply apparatus 13 will be described in detail with reference to another drawing.

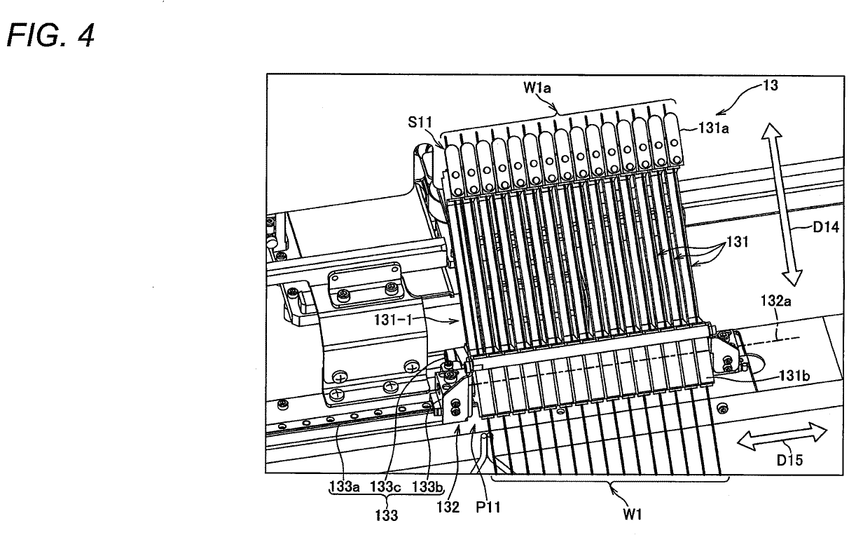

FIG. 4 is an external appearance perspective view showing the electric wire supply portion shown in FIGS. 1 and 2. FIG. 4 is a perspective view of the electric wire supply apparatus 13 as viewed from the electric wire storage rack 12 in FIG. 1.

The electric wire supply apparatus 13 includes a plurality of electric wire holding arms 131, a holding frame 132, and a movement mechanism 133.

The electric wire holding arm 131 is formed in a rod shape, and detachably holds one electric wire W1 along a length direction D14 thereof, has one end side as an electric wire protruding end portion 131a, and causes a tip end W1a of the electric wire W1 to protrude from the electric wire protruding end portion 131a. The electric wire supply apparatus 13 is provided with the plurality of electric wire holding arms 131 that hold the plurality of types of electric wires W1 in a one-to-one manner. The electric wire holding arm 131 will be described in more detail later.

The holding frame 132 is a member that arranges and holds the plurality of electric wire holding arms 131 side by side in a width direction D15 intersecting the length direction D14 of the electric wire holding arm 131. In addition, in this holding, each of the electric wire holding arms 131 is individually held to be movable between two postures of a standby posture S11 and an electric wire supply posture described later. FIG. 4 shows the electric wire supply apparatus 13 in a state in which all holding frames 132 are in the standby posture S11. The standby posture S11 is a posture in which the length direction D14 of the electric wire holding arm 131 is aligned with the length direction D14 of the other wire holding arm 131 in a standing state in which the electric wire protruding end portion 131a is higher than an end portion 131b on an opposite side. On the other hand, the electric wire supply posture is as follows.

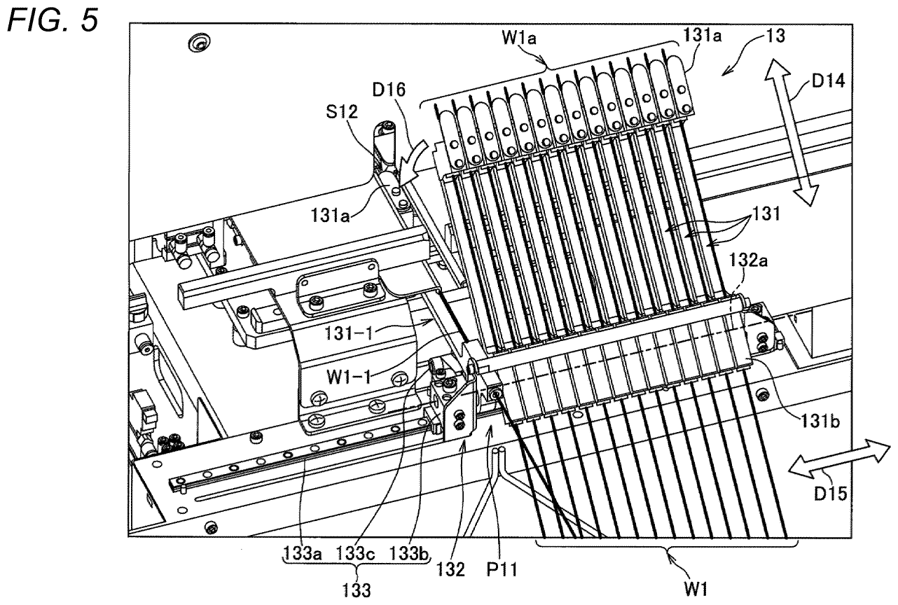

FIG. 5 is a view showing a state in which a supply arm is shifted to the electric wire supply posture in the electric wire supply portion shown in FIG. 4. FIG. 5 shows a state in which, of the plurality of electric wire holding arms 131 arranged side by side, a supply arm 131-1 at a left end is shifted to an electric wire supply posture S12 when viewed from the electric wire storage rack 12 in FIG. 1. The electric wire supply posture S12 is a posture in which the supply arm is tilted in a direction indicated by an arrow 16 such that the electric wire protruding end portion 131a is lower than the electric wire protruding end portion 131a of the other electric wire holding arm 131.

The holding frame 132 individually holds each of the plurality of electric wire holding arms 131 such that the electric wire holding arm 131 is movable between the standby posture S11 and the electric wire supply posture S12. Specifically, the holding frame 132 is configured to individually hold each of the electric wire holding arms 131 such that the electric wire holding arm 131 is rotatable between the standby posture S11 and the electric wire supply posture S12 around a rotation shaft 132a intersecting the end portion 131b on the opposite side.

When an electric wire to be supplied W1-1 is selected, the movement mechanism 133 moves the holding frame 132 such that the supply arm 131-1 that holds the electric wire W1-1 among the plurality of electric wire holding arms 131 is positioned at a predetermined supply position P11. The supply position P11 is a position at which the tip end W1a of the electric wire W1-1 protruding from the electric wire protruding end portion 131a enters the feed-out mechanism 16a-1 shown in FIG. 2 when the supply arm 131-1 moves to the electric wire supply posture S12. After the holding frame 132 is moved and the supply arm 131-1 is positioned at the supply position P11, the movement mechanism 133 moves the supply arm 131-1 to the electric wire supply position S12 at the supply position P11. The movement mechanism 133 includes a holding rail 133a, a slide driving unit 133b, and an arm driving unit 133c.

The holding rail 133a is a rail that passes through the supply position P11 and that extends along an arrangement direction of the electric wire holding arms 131 in the holding frame 132 (that is, the width direction D15 of the electric wire holding arm 131). Then, the holding rail 133a slidably holds the holding frame 132 that holds the plurality of electric wire holding arms 131 arranged side by side in the standby posture S11.

The slide driving unit 133b slides the holding frame 132 on the holding rail 133a such that the supply arm 131-1 of the plurality of electric wire holding arms 131 arranged side by side is positioned at the supply position P11. An example of a drive source in the slide driving unit 133b is a servo motor or the like.

The arm driving unit 133c rotates the supply arm 131-1 positioned at the supply position P11 from the standby posture S11 to the electric wire supply posture S12 around the rotation shaft 132a and tilts the supply arm 131-1 down. An example of a drive source in the arm driving unit 133c is a general motor or the like other than a cylinder.

Next, the electric wire holding arm 131 will be described in more detail.

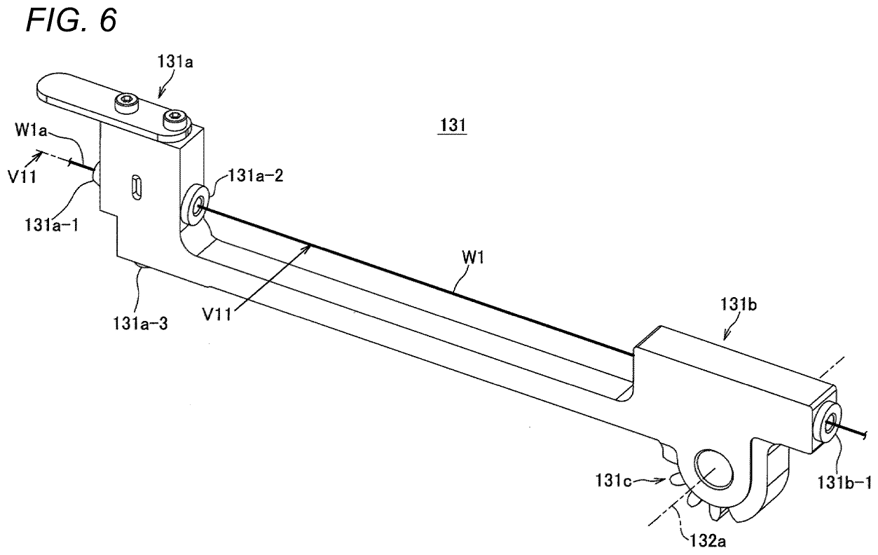

FIG. 6 is a perspective view showing only one of the electric wire holding arms shown in FIGS. 4 and 5.

As shown in FIG. 6, the electric wire holding arm 131 is formed in a rod shape that is recessed in a U shape in which a portion excluding both end portions is flat. The electric wire W1 is passed and held between the electric wire protruding end portion 131a and the end portion 131b on the opposite side in a state in which the electric wire W1 is exposed in this recessed portion. A gear tooth 131c that receives a rotation driving force from the arm driving unit 133c is provided on the end portion 131b on the opposite side, the electric wire holding arm 131 rotates around the rotation shaft 132a by receiving the rotation driving force by the gear tooth 131c. Further, the inside of the end portion 131b on the opposite side is formed in a cylindrical shape through which the electric wire W1 passes, and a lead-in port 131b-1 of the electric wire W1 extending from the electric wire storage rack 12 is provided at an end portion on a side of the electric wire storage rack 12 shown in FIG. 2.

On the other hand, in the electric wire protruding end portion 131a, a lead-in port 131a-2 that receives the electric wire W1 passing through a U-shaped recess through the end portion 131b on the opposite side is provided at a portion facing the inside of the U-shaped recess. The tip end W1a of the electric wire W1 that enters the inside of the electric wire protruding end portion 131a from the lead-in port 131a-2 protrudes to the outside from a lead-out port 131a-1 on the opposite side.

Here, in the present embodiment, the electric wire holding arm 131 causes the tip end W1a of the electric wire W1 to protrude and releasably grips a portion near the tip end of the electric wire W1 at the electric wire protruding end portion 131a. Further, a switching button 131a-3 for switching between a gripping state in which the portion near the tip end of the electric wire W1 is gripped and a released state in which gripping of the portion near the tip end is released and the portion near the tip end is opened is provided at the electric wire protruding end portion 131a. A gripping mechanism of the portion near the tip end of the electric wire W1 including the switching button 131a-3 is configured as follows.

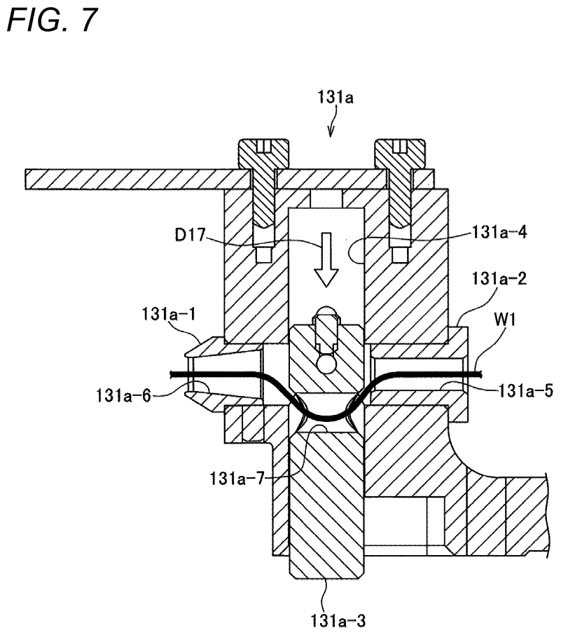

FIG. 7 is a cross-sectional view showing a cross section of the electric wire protruding end portion of the electric wire holding arm shown in FIG. 6 along a line V11-V11 in the drawing.

As shown in FIG. 7, the electric wire protruding end portion 131a is provided with a vertical hole space 131a-4 that intersects passages 131a-5 and 131a-6 of the electric wire W1 from the lead-in port 131a-2 to the lead-out port 131a-1. In the vertical hole space 131a-4, a rod-shaped object is accommodated to expose a lower end portion to the outside, and the exposed lower end portion is the switching button 131a-3. A horizontal hole space 131a-7 capable of communicating with the passages 131a-5 and 131a-6 of the electric wire W1 is provided in an intermediate portion of the rod-shaped object. At this time, the rod-shaped object is biased in a biasing direction D17 in which the switching button 131a-3 is pushed out by a biasing member such as a spring (not shown). By this biasing, normally, the passages 131a-5 and 131a-6 of the electric wire W1 and the horizontal hole space 131a-7 are displaced in the biasing direction D17. The gripping of the portion near the tip end of the electric wire W1 is performed by clamping the electric wire W1 between edges of the passages 131a-5 and 131a-6 and an edge of the horizontal hole space 131a-7 in a displaced state and applying a biasing force thereto. When the gripping is released or the portion near the tip end of the electric wire W1 is attached, the switching button 131a-3 is pushed into the vertical hole space 131a-4, and thus the displacement of the passages 131a-5 and 131a-6 and the horizontal hole space 131a-7 is eliminated and the passages 131a-5 and 131a-6 and the horizontal hole space 131a-7 are communicated. Then, after the portion near the tip end of the electric wire W1 is passed through the passages 131a-5, 131a-6 and the horizontal hole space 131a-7 that are communicated, when the switching button 131a-3 is released, the switching button 131a-3 is pushed down by the biasing force, the displacement occurs again, and the portion near the tip end of the electric wire W1 is gripped. The griping by the biasing force is weak to such an extent that the feeding out of the electric wire W1-1 by the feed-out mechanism 16a-1 shown in FIG. 2 is not hindered.

In the electric wire supply apparatus 13 and the electric wire processing apparatus 1 of the embodiment described above, the plurality of electric wire holding arms 131 that detachably hold the plurality of types of electric wires W1 are arranged side by side in which each of the electric wire holding arms 131 is in the standing state at a non-supply time when the electric wire is not supplied. The operator Y who performs a replacement operation or the like of the electric wire W1 at such a non-supply time can access the desired one electric wire holding arm 131 from among the plurality of electric wire holding arms 131 positioned at substantially the same height, and can easily replace the electric wire W1 that is individually detachably held. Further, even at a supply time of the electric wire W1, other than the supply arm 131-1 that is shifted to the electric wire supply posture S12, the electric wire holding arms 131 are arranged side by side in the standing state as at the non-supply time. Therefore, the operator Y can access the desired one electric wire holding arm 131 from among the electric wire holding arms 131 in the standing state and can easily replace the electric wire W1 even at the supply time not only the non-supply time. As described above, according to the present embodiment, regardless of whether the electric wire W1 is not supplied or supplied, the desired one electric wire holding arm 131 can be accessed and the electric wire W1 can be easily replaced, so that the electric wire replacement can be performed efficiently.

Here, in the present embodiment, each of the electric wire holding arms 131 is individually held such that the electric wire holding arm 131 is rotatable between the standby posture S11 and the electric wire supply posture S12 around the rotation shaft 132a intersecting the end portion 131b on the opposite side of the electric wire protruding end portion 131a. According to this configuration, a swing width of movement of the electric wire protruding end portion 131a between the standby posture S11 and the electric wire supply posture S12 of the electric wire holding arm 131 increases. Since the electric wire protruding end portion 131a moves with such a large swing width, the operator Y can easily distinguish the standby posture S11 and the electric wire supply posture S12 from each other by visual inspection, and workability of the electric wire replacement can be improved.

In the present embodiment, the movement mechanism 133 includes the holding rail 133a that slidably holds the holding frame 132, the slide driving unit 133b that slides the holding frame 132, and the arm driving unit 133c that tilts the supply arm 131-1. According to this configuration, due to the slide of the holding frame 132 and the tilting of the supply arm 131-1 by the movement mechanism 133, the electric wire supply apparatus 13 can be smoothly shifted to a state in which the electric wire can be supplied.

Further, in the present embodiment, the electric wire holding arm 131 releasably grips the portion near the tip end of the electric wire W1 at the electric wire protruding end portion 131a. According to this configuration, since the electric wire W1 can be easily replaced by opening the griping of the electric wire W1 at the electric wire protruding end portion 131a, the workability for the electric wire replacement can be improved.

Further, in the present embodiment, the switching button 131a-3 for switching between the gripping state in which the portion near the tip end of the electric wire W1 is gripped and the released state in which the portion near the tip end is opened is provided at the electric wire protruding end portion 131a. According to this configuration, since the electric wire W1 can be gripped and opened at the electric wire protruding end portion 131a by operating the switching button 131a-3, the workability for the electric wire replacement can be further improved.

The embodiment described above merely shows representative forms of the electric wire supply apparatus and the electric wire processing apparatus, and the electric wire supply apparatus and the electric wire processing apparatus are not limited to this embodiment. That is, the electric wire supply apparatus and the electric wire processing apparatus can be variously modified and implemented without departing from the gist thereof.

For example, in the above-described embodiment, as an example of the electric wire supply apparatus and the electric wire processing apparatus, the electric wire supply apparatus 13 and the electric wire processing apparatus 1 in which the electric wire W1-1 is selected via the part number data are illustrated. However, the electric wire supply apparatus and the electric wire processing apparatus are not limited thereto, and, for example, the electric wire may be directly selected, and a specific designation mode is not limited.

Further, in the above-described embodiment, as an example of the holding frame, the holding frame 132 is illustrated in which the electric wire holding arm 131 is held such that the electric wire holding arm 131 is rotatable between the standby posture S11 and the electric wire supply posture S12 around the rotation shaft 132a passing through the end portion 131b on the opposite side. However, the holding frame is not limited thereto, and as long as the electric wire holding arm is held such that the electric wire holding arm is movable between the standby posture in the standing state and the tilted electric wire supply posture, a specific movement mode between the two postures is not limited. However, as described above, the workability for the electric wire replacement can be improved by adopting the rotation around the rotation shaft 132a.

In the above-described embodiment, as an example of the movement mechanism, the movement mechanism 133 including the holding rail 133a, the slide driving unit 133b, and the arm driving unit 133c is illustrated. However, the movement mechanism is not limited thereto, and as long as the movement mechanism performs the movement of the holding frame and the movement of the supply arm, a specific movement mode of the movement mechanism is not limited. However, as described above, according to the movement mechanism 133 in which the slide driving using the holding rail 133a and the arm driving are combined, the electric wire supply apparatus 13 can be smoothly shifted to the state in which the electric wire can be supplied.

In addition, in the above-described embodiment, as an example of the electric wire holding arm, the electric wire holding arm 131 that releasably grips the portion near the tip end of the electric wire W1 at the electric wire protruding end portion 131a is illustrated. However, the electric wire holding arm is not limited thereto, and as long as the electric wire holding arm detachably holds the electric wire, a specific holding mode is not limited, for example, the electric wire may be held by a clip or the like. However, as described above, the workability for the electric wire replacement can be improved by adopting the releasable griping.

Further, in the above-described embodiment, as an example of the electric wire holding arm, the electric wire holding arm 131 provided with the switching button 131a-3 for switching between the gripping state and the released state of the electric wire W1 is illustrated. However, the electric wire holding arm is not limited thereto, and may be one without such a button. However, as described above, the workability for electric wire replacement can be further improved by providing the switching button 131a-3.

### REFERENCE SIGNS LIST

1 electric wire processing apparatus
1a apparatus body
11 information acquisition unit
12 electric wire storage rack
13 electric wire supply apparatus
14 B-side terminal supply portion
15 A-side terminal supply portion
16 body mechanism
16a cut-out portion
16a-1 feed-out mechanism
16a-2 cutting mechanism
17a A-side rubber plug supply portion
17b B-side rubber plug supply portion
121 rack body
122 electric wire reel
131 electric wire holding arm
131-1 supply arm
131a electric wire protruding end portion
131a-1 lead-out port
131a-2, 131b-1 lead-in port
131a-3 switching button
131a-4 vertical hole space
131a-5, 131a-6 passage
131a-7 horizontal hole space
131b end portion on opposite side
132 holding frame
132a rotation shaft
133 movement mechanism
133a holding rail
133b slide driving unit
133c arm driving unit
161 A-side crimping machine
162 A-side rubber plug inserting machine
163 A-side electric wire moving arm
164 B-side crimping machine
165 B-side rubber plug inserting machine
166 B-side electric wire moving arm
D11 feed-out direction
D12, D13, D16 arrow
D14 length direction
D15 width direction
D17 biasing direction
P11 supply position
S11 standby posture
S12 electric wire supply posture
T11 A-side terminal
T12 B-side terminal
TR1 terminal reel
TR11 terminal chain body
TR11a terminal
TR11b carrier
W1 electric wire
W1a tip end
W1-1 electric wire
W11 terminal-equipped electric wire
W111 segment electric wire
Y operator

What is claimed is:

1. An electric wire supply apparatus comprising:
an electric wire holding arm formed in a rod shape, configured to detachably hold one electric wire along a length direction of the electric wire holding arm, having one end side as an electric wire protruding end portion from which a tip end of the electric wire protrudes;
a holding frame configured to arrange a plurality of the electric wire holding arms side by side with each other along a width direction intersecting the length direction of the electric wire holding arm, each of the plurality of the electric wire holding arms configured to hold respective one of the electric wires of different types, the holding frame being configured to individually hold each of the electric wire holding arms such that each of the electric wire holding arms is movable between a standby posture, in which the length direction of the electric wire holding arm is aligned with the length direction of another electric wire holding arm with the electric wire holding arm being in a standing state in which the electric wire protruding end portion is positioned higher than an end portion on an opposite side of the electric wire holding arm, and an electric wire supply posture in which the electric wire holding arm is tilted such that the electric wire protruding end portion of the electric wire holding arm is positioned lower than the electric wire protruding end portion of the another electric wire holding arm; and
a movement mechanism configured to, when an electric wire to be supplied is selected out of the electric wires of different types, move the holding frame such that a supply arm, which is one of the plurality of electric wire holding arms, configured to hold the selected electric wire among the plurality of electric wire holding arms is positioned at a predetermined supply position and then move the supply arm to the electric wire supply posture at the supply position.

2. The electric wire supply apparatus according to claim 1,
wherein the holding frame is configured to individually hold each of the electric wire holding arms such that the electric wire holding arm is rotatable between the standby posture and the electric wire supply posture about a rotation shaft intersecting the end portion on the opposite side.

3. The electric wire supply apparatus according to claim 1,
wherein the movement mechanism includes:
a holding rail configured to slidably hold the holding frame holding the plurality of electric wire holding arms arranged side by side with each other in the standby posture, the holding rail being a rail that passes through the supply position and extending along an arrangement direction of the electric wire holding arms in the holding frame;
a slide driving unit configured to slide the holding frame on the holding rail such that the supply arm of the plurality of electric wire holding arms arranged side by side is positioned at the supply position; and
an arm driving unit configured to tilt the supply arm positioned at the supply position from the standby posture to the electric wire supply posture.

4. The electric wire supply apparatus according to claim 1,
wherein the electric wire holding arm is configured to have the tip end of the electric wire protrude and to grip a portion of the electric wire in vicinity of the tip end of the electric wire in a releasable manner at the electric wire protruding end portion.

5. The electric wire supply apparatus according to claim 4,
wherein the electric wire holding arm is provided with a switching button at the electric wire protruding end portion, the switching button being configured to switch between a gripping state in which the portion of the electric wire in the vicinity of the tip end is gripped and a released state in which gripping of the portion of the electric wire in the vicinity of the tip end is released and the portion of the electric wire in the vicinity of the tip end is released.

6. An electric wire processing apparatus comprising:
the electric wire supply apparatus according to claim 1; and
an apparatus body configured to be supplied with the electric wire by pulling out the electric wire from the electric wire protruding end portion of the supply arm having been moved to the electric wire supply posture in the electric wire supply apparatus, and to cut out a segment electric wire from the electric wire and to manufacture a terminal-equipped electric wire by crimping a terminal to at least one end of the segment electric wire.
